(19) United States
(12) Patent Application Publication
(10) Pub. No.: US 2007/0083916 A1
(43) Pub. Date: Apr. 12, 2007

(54) System for authentication of electronic devices

(76) Inventor: William Coyle, San Jose, CA (US)

Correspondence Address: AVAGO TECHNOLOGIES, LTD., P.O. BOX 1920, DENVER, CO, 80201-1920, US

(21) Appl. No.: 11/245,698

(22) Filed: Oct. 7, 2005

(51) Int. Cl. H04L 9/32

(52) U.S. Cl. 726/4

(57) ABSTRACT

A system for authenticating an electronic device includes sending a character from a host to the electronic device, encoding the character in the electronic device to provide an encoded character, calculating an expected response at the host, and comparing the encoded character from the electronic device with the expected response. The electronic device is authenticated when the encoded character matches the expected response.

### BACKGROUND

The present invention relates generally to electronic devices, and more particularly to a system for authenticating electronic devices.

There have been several attempts by various companies to provide electronic device authentication. The prior solution used, was to encode in a section of a memory device, such as an electrically erasable programmable read only memory (EEPROM), an identification number such as the serial number of the electronic device and to place the results at some other EEPROM address. The device serial number would be read and the encoded bytes calculated. The encoded bytes from the device would also be read and compared to the calculated bytes. The device would be considered authentic when these bytes matched. Since every device had a unique serial number, the encoded bytes would be different for each device.

This worked well to differentiate one device from another of a different legitimate manufacturer. This did not work for counterfeiters willing to copy the complete contents of an authentic device. Simply copying every byte from an authentic module defeated this system. The counterfeiters could easily do this since they created their own counterfeit modules and were able to place copied contents in their own EEPROMs. This also results in the unauthorized use of the company logo and copyright in addition to defeating the anti-counterfeiting scheme.

To prevent the counterfeiting using one authentic module, one vendor designed their electronic device to detect duplicate serial numbers and to reject them as counterfeits. This handled the case where one authentic module was duplicated. In order to avoid this, counterfeiters simply duplicated sets of multiple authentic modules.

Any authentication solution that depends on static or unchanging contents can be defeated by the simple measure of copying all contents of authentic modules.

Solutions to these problems have been long sought but prior developments have not taught or suggested any solutions and, thus, solutions to these problems have long eluded those skilled in the art.

### DISCLOSURE OF THE INVENTION

The present invention provides a system for authenticating an electronic device including sending a character from a host to the electronic device, encoding the character in the electronic device to provide an encoded character, calculating an expected response at the host, and comparing the encoded character from the electronic device with the expected response. The electronic device is authenticated when the encoded character matches the expected response.

Certain embodiments of the invention have other features in addition to or in place of those mentioned above. The features will become apparent to those skilled in the art from a reading of the following detailed description when taken with reference to the accompanying drawings.

### BRIEF DESCRIPTION OF THE DRAWINGS

FIG. 1 is a block diagram of the system for authenticating electronic devices manufactured in accordance with an embodiment of the present invention;

FIG. 2 is a logic diagram of a system for authenticating electronic devices manufactured in accordance with an embodiment of the present invention; and

FIG. 3 is a flow chart of the system for authenticating electronic devices in accordance with an embodiment of the present invention.

### BEST MODE FOR CARRYING OUT THE INVENTION

In the following description, numerous specific details are given to provide a thorough understanding of the invention. However, it will be apparent that the invention may be practiced without these specific details. In order to avoid obscuring the present invention, some well-known system configurations and process steps are not disclosed in detail.

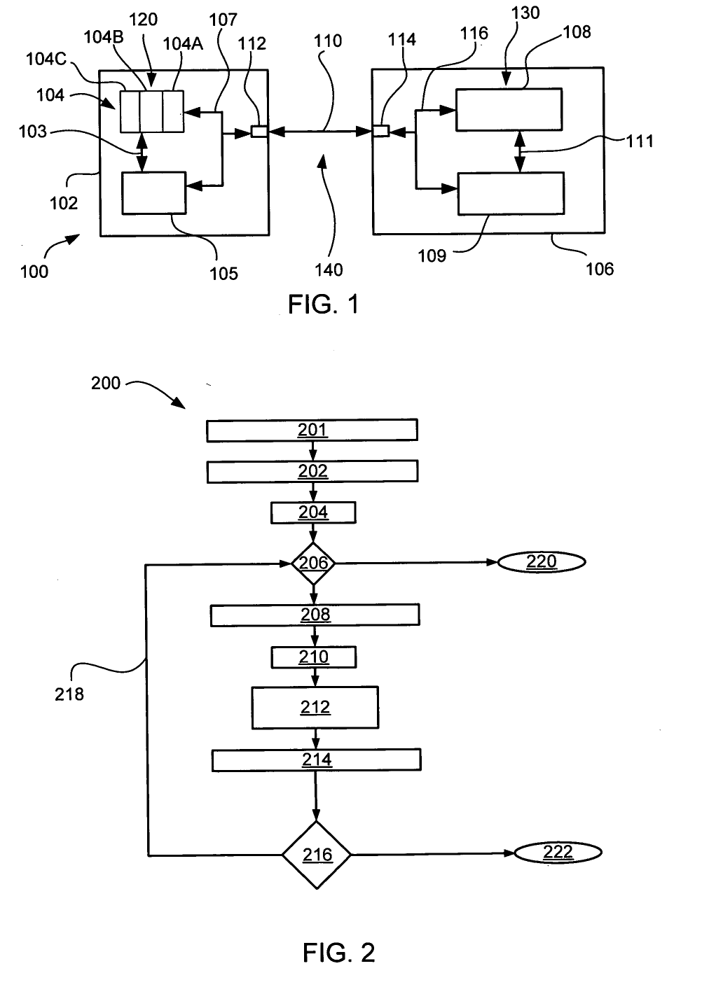

Referring now to FIG. 1, therein is shown a block diagram of an authentication system 100 for authenticating electronic devices manufactured in accordance with an embodiment of the present invention. The system includes an electronic device 102, such as an integrated circuit (IC). The electronic device 102 has a first memory 104, such as an electrically erasable programmable read only memory (EEPROM), which is configured to actively respond to a command, such as a register write and read command, and provide a response.

The first memory 104 has a receiving storage location 104A, an encoded storage location 104B, and a protected storage location 104C. The receiving storage location 104A and the encoded storage location 104B can be the same storage location in the first memory 104.

In manufacturing the electronic device 102, the memory 104 of the electronic device 102 is divided into storage areas as follows: the receiving storage location 104A is non-permanent and temporary memory space containing work area used for temporary storage of the inputs, intermediate results and final results of various data processing operations.

The encoded storage location 104B is semi-permanent and modifiable memory space containing data generated for the user and held for the user by the memory 104. The contents of the encoded storage location 104B is utilized by the electronic device 102 to perform the necessary encryption, but is never disclosed outside the electronic device 102.

The protected storage location 104C is permanent and non-modifiable memory space containing data and firmware embedded into the electronic device 102 during manufacture of the electronic device 102.

The protected storage location 104C is protected from tampering or unauthorized access that might reveal the contents or alter the modes of operation. For example, the contents of the protected storage location 104C can be protected from tampering through the use of a selected bit or bits in the stored data to permit only an authorized processor to access the contents of the protected storage location 104C. One example of such a protection system includes a processor that has on-chip memory. Protection of the contents of the on-chip memory is provided by designating a bit or bit in the contents of the on-chip memory that allows access to the contents of the on-chip memory only by the processor that is on the same integrated circuit chip as the on-chip memory. A device with such characteristics is sometimes referred-to as a tamper-resistant secure (read protected) module. It will be apparent to those skilled in the art upon a reading of this disclosure that other means of protecting the contents of the protected memory location 104C also can be used.

The protected storage location 104C stores an encoding algorithm, such as a hash algorithm, to be used during authentication. The protected storage location 104C is non-readable in the sense that it can only be accessed or read by a device processor 105 during authentication. Thus, the algorithm stored in the protected storage location 104C is not readable by anyone in the outside world and the protected storage location 104C can only be read or modified with complete erasure of the contents and the protection bits. It is not just encrypted but is not readable at all. It is assumed that the owner has a copy of the software/firmware and does not need to look at it.

Depending on the design of the electronic device 102, the receiving storage location 104A, the encoded storage location 104B, and the protected storage location 104C could each reside in a different type of memory storage system, such as ROM, RAM, EEPROM or FLASH memory.

Another approach is to use FLASH memory for both permanent and non-permanent data.

Yet another approach is to utilize a chip operating system that would manage the microprocessor's memory using a directory of objects. In this manner the device processor 105 can readily enforce the desired level of protection based on the code contained in the relevant directory entry for the data object. This scheme can also apply to firmware code routines as well as to data, and may be advantageously applied when upgrading or replacing trusted firmware code routines without needing to physically replace the electronic device 102 or any of its memory 104.

Typically, the electronic device 102 includes the device processor 105, which can be a microprocessor, microcontroller, other processing circuitry, and combinations thereof. The device processor 105 is connected to the first memory 104 by a first bus 103. The device processor 105, the first memory 104, and the first bus 103 comprise a system for generating an encoded, or calculated, character in the electronic device 102.

A host 106, such as a controller or router, includes a second memory 108 and a host processor 109. The second memory 108 is protected from reverse engineering by the vendor by the same mechanisms that the vendor uses to protect its own code. The second memory 108 includes an encoding algorithm, such as a hash algorithm, that is used to encode the same random characters sent to the electronic device 102.

The contents of the second memory 108 are restricted to access only by the host processor 109 for purposes of calculating an expected response from the electronic device 102 in a suitable manner such as that disclosed above with respect to the protected storage location 104C and the device processor 105. Thus, the algorithm stored in the second memory 108 is not readable by the user of the host 106 at any time.

The host processor 109, the second memory 108, and a second bus 111 comprise a system for randomly generating a character to be encoded, for encoding the selected character for calculating an expected response, and for comparing the expected response with the calculated response.

The host 106 is connected to the electronic device 102 using a communication link 110, such as a serial two-wire interface (12C). The electronic device 102 has a first communication port 112 and the host 106 has a second communication port 114 for connection to the communication link 110. The first communication port 112 is connected to the first memory 104 and the device processor 105 by a third bus 107. The second communication port 114 is connected to the second memory 108 and the host processor 109 by a fourth bus 116. There is thus provided a system for communication between the electronic device 102 and the host 106.

It will be understood upon a reading of this disclosure that the communication link 110 can be any suitable link between the electronic device 102 and the host 106. For example, when the host 106 is remote from the electronic device 102, the communication link 110 can be a link provided by a local area network (LAN), wide area network (WAN), the Internet, or other network link.

Referring now to FIG. 2, therein is shown a logic diagram of a system 200 for authenticating electronic devices in accordance with an embodiment of the present invention with reference to the system 100 shown in FIG. 1. Upon initiation of a query in a logic block 201 from the host 106 to the electronic device 102 the host 106 sends an initialization signal selected by the host processor 109 using the communication link 110 in a logic block 202, such as a “0” to the first memory 104 in the electronic device 102 to reset and initialize the hashing code.

The host 106 enters a first wait state in a logic block 204 while the electronic device 102 processes the initialization signal. The system in the electronic device 102 for encoding the character(s) received from the host 106 comprises the first memory 104 and the device processor 105.

The device processor 105 in the electronic device 102 uses the hash algorithm stored in the protected storage location 104C to calculate a response to the initialization signal. The electronic device 102 responds using the communication link 110 with an expected signal, such as a “1”, that is sent to the host 106 upon completion of the initialization of the electronic device 102. Additional start parameters, such as a seed of the encoding algorithm, also may be sent to the electronic device 102 using the communication link 110 when required or desirable by repeating the initialization process described above.

The host 106 then sends a character using the communication link 110 in a logic block 208 to the electronic device 102 to be encoded using the encoding algorithm stored in the first memory 104. Typically, the character sent to the electronic device 102 is any character or number that is randomly selected by the host 106 to reduce the chances of anyone trying to obtain the encoding algorithm stored in the second memory 108 by reverse engineering the authentication system 100 of the present invention. A person trying to reverse engineer the authentication system 100 would have to know the encoding algorithm and could not just duplicate the transactions between the electronic device 102 and the host 106.

The host 106 then enters a second wait state in a logic block 210 for the electronic device 102 to respond. The host 106 includes a host processor 109 that can use at least one of waiting for a predetermined amount of time, continually reading the output of the first memory 104 in the electronic device 102 until the value changes, and combinations thereof.

The host 106 reads the first memory 104 using the communication link 110 in a logic block 212. The host processor 109 calculates what the response from the electronic device 102 should be by using the encoding algorithm stored in the second memory 108 in a logic block 214 and compares the results of that calculation with the response sent from the electronic device 102 using the communication link 110 in a logic block 216. The host can send multiple characters to the electronic device 102 in a loop 218 by repeating this query and response method. The electronic device 102 is authenticated in a logic block 220 only when the returned characters match those expected by the host 106 as a result of the calculation and comparison performed by the host 106.

When the returned characters do not match those expected by the host 106 as a result of the calculation performed by the host 106, the electronic device 102 fails and is not authenticated in a logic block 222.

It has been discovered that the present invention provides authentication of an electronic device 102, which is difficult to be duplicated by a counterfeiter. The host 106 sends via the communication link 110 a series of random numbers or characters to the electronic device 102 for encoding by the electronic device 102 in accordance with an encoding algorithm. The encoding algorithm cannot be simply copied from its protected storage location locations in the electronic device 102 or the host 106. The encoding algorithm need be known only by the electronic device manufacturer and the vendors who will incorporate it into their equipment. The ability to copy the algorithm by potential counterfeiters is thus reduced.

Thus, the system of the present invention overcomes the problems associated with prior attempts to provide electronic device authentication. Identification numbers such as the serial number of the electronic device are not relied upon during authentication and need not be placed in memory for authentication, therefore the device serial number cannot be read by potential counterfeiters.

Accordingly, even counterfeiters willing to copy the complete contents of an authentic device cannot defeat the system by simply copying every byte from an authentic electronic device.

The authentication system of the present invention does not depend on static or unchanging contents and cannot be defeated by the simple measure of copying all contents of authentic electronic devices.

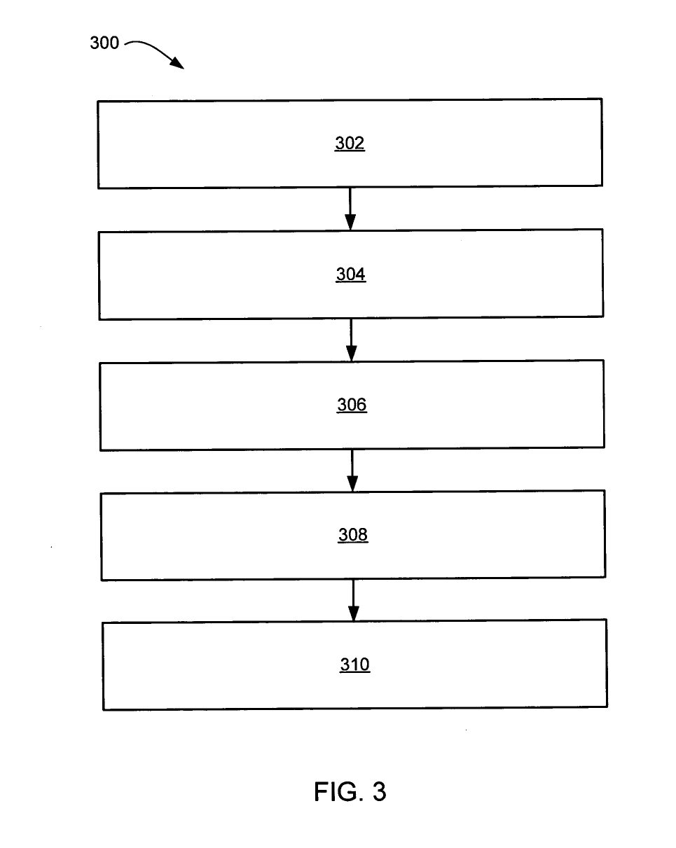

Referring now to FIG. 3, therein is shown a flow chart of the authentication system 300 for authenticating electronic devices in accordance with the present invention. The authentication system 300 includes sending a character from a host to the electronic device in a block 302; encoding the character in the electronic device to provide an encoded character in a block 304; calculating an expected response at the host in a block 306; comparing the encoded character from the electronic device with the expected response in a block 308; and authenticating the electronic device when the encoded character from the electronic device matches the expected response in a block 310.

Thus, it has been discovered that the system of the present invention furnishes important and heretofore unavailable solutions, capabilities, and functional advantages for authenticating electronic devices. The resulting process and configurations are straightforward, economical, uncomplicated, highly versatile and effective, use conventional technologies, and are thus readily suited for manufacturing electronic devices that are fully compatible with conventional manufacturing processes and technologies.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

The invention claimed is:

1. A system for authenticating an electronic device, comprising:
sending a character from a host to the electronic device;
encoding the character in the electronic device to provide an encoded character;
calculating an expected response at the host;
comparing the encoded character from the electronic device with the expected response; and
authenticating the electronic device when the encoded character from the electronic device matches the expected response.

2. The system as claimed in claim 1, wherein:
encoding the character in the electronic device and calculating the expected response at the host uses a hash algorithm.

3. The system as claimed in claim 1, wherein:
encoding uses an algorithm readable only during authentication.

4. The system as claimed in claim 1, wherein:
sending a character from the host to the electronic device randomly selects the character.

5. The system as claimed in claim 1, further comprising:
initializing the electronic device by sending an initialization signal to the electronic device from the host; and
receiving at the host an expected response from the electronic device indicative of receipt of the initialization signal from the host.

6. The system as claimed in claim 1, further comprising:
storing an encoding algorithm in a protected storage location in the electronic device and the host.

7. The system as claimed in claim 1, further comprising:
reading the encoded character in the electronic device after sending the character from the host using at least one of waiting a predetermined time, continually reading the location of the encoded character until it changes, and combinations thereof.

8. An electronic device configured for authentication, comprising:
a protected storage location;
an encoding algorithm stored in the protected storage location;
a receiving storage location for receiving from a host a character to be encoded using the encoding algorithm to provide an encoded character;
an encoded storage location for storing the encoded character; and
a communication link for connecting the electronic device to the host.

9. The electronic device as claimed in claim 8, wherein:
the encoding algorithm comprises a hash algorithm.

10. The electronic device as claimed in claim 8, further comprising:
a system for initializing the electronic device by receiving an initialization signal from the host; and
a system for sending a calculated response from the electronic device indicative of receipt of the initialization signal from the host.

11. The electronic device as claimed in claim 8, wherein the electronic device comprises an integrated circuit.

12. The electronic device as claimed in claim 8, wherein the protected storage location comprises an EEPROM.

13. The electronic device as claimed in claim 8, wherein the receiving storage location and the encoded storage location comprise one storage location addressable by the host.

14. The electronic device as claimed in claim 8, wherein the system for connecting the electronic device to the host comprises:
a first port for at least one of a serial two-wire interface, a local area network, a wide area network, the internet, and combinations thereof.

15. A host for authenticating an electronic device, comprising:
a processor;
a protected storage locationaccessable by the processor;
an encoding algorithm stored in the protected storage location;
a communication link for connecting the host to the electronic device;
a system for generating a character to be sent using the communication link to the electronic device for encoding;
a system for encoding the character in accordance with the encoding algorithm to provide a calculated character;
a system for receiving an encoded character from the electronic device using the communication link;
a system for comparing the encoded character from the electronic device with the calculated character; and
a system for authenticating the electronic device when the encoded character matches the calculated character.

16. The host as claimed in claim 15, wherein the host comprises at least one of a controller, a microprocessor, a router, and combinations thereof.

17. The host as claimed in claim 15, further comprising:
a system for initializing the electronic device by sending an initialization signal from the host; and
a communication link for receiving an expected response from the electronic device indicative of receipt of the initialization signal from the host.

18. The host as claimed in claim 15, wherein the protected storage location comprises an EEPROM.

19. The host as claimed in claim 15, wherein the means for receiving an encoded character from the electronic device further comprises:
a system for reading the encoded character in the electronic device after sending the character from the host using at least one of waiting a predetermined time, continually reading the location of the encoded character until it changes, and combinations thereof.

20. The host as claimed in claim 15, wherein the means for connecting the host to the electronic device comprises:
a second port for at least one of a serial two-wire interface, a local area network, a wide area network, the internet, and combinations thereof.
